(19) United States
(12) Patent Application Publication
(10) Pub. No.: US 2026/0246135 A1
(43) Pub. Date: Aug. 20, 2026

(54) Broadband Notch Antenna

(71) Applicant: Vitro Automotive Holdings Corporation, Cheswick, PA (US)

(72) Inventor: David Dai, Cheswick, PA (US)

(21) Appl. No.: 19/449,343

(22) Filed: Jan. 14, 2026

Related U.S. Application Data
(60) Provisional application No. 63/745,678, filed on Jan. 15, 2025.

(51) Int. Cl. H01Q 1/12

(52) U.S. Cl. CPC H01Q 1/1271

(57) ABSTRACT

An antenna assembly may include a dielectric substrate, a plurality of conductive sheets disposed on a side of the dielectric substrate, a plurality of notch radiators defined between at least two of the plurality of conductive sheets, and a transmission line electrically connected to at least one of the plurality of conductive sheets.

### CROSS REFERENCE TO RELATED APPLICATIONS

This application claims priority to U.S. Provisional Application No. 63/745,678, filed on Jan. 15, 2025, the disclosure of which is hereby incorporated by reference in its entirety.

### BACKGROUND OF THE INVENTION

### Field of the Invention

The present application relates to a broadband notch antenna and a single feed antenna having a plurality of notch radiators disposed on window glass. The antennas transmit and receive electromagnetic waves for wireless communications.

### Description of Related Art

In automotive transparencies, antennas for the reception and/or transmission of radio frequency waves such as, for example, AM, FM, TV, DAB, RKE, etc., are often carried on or incorporated into the transparent parts of the vehicle. Examples of these transparent parts include rear and front windshields, side windows, and sunroofs, which are typically formed by glass or other transparent materials. Such antennas have traditionally been formed by printing conductive lines such as silver or copper onto the transparent parts or by laminating metal wires or strips between layers of vehicle window glass. Such antennas offer advantages of aerodynamic performance of the vehicle as well as providing the vehicle with an aesthetically pleasing, streamline appearance

Advancements in the automotive industry, particularly those related to autonomous driving, has led to the development of features such as, for example, advanced safety systems, Dedicated Short Range Communications (DSRC) radios for vehicle-to-vehicle (V2V) and vehicle-to-infrastructure (V2I) communications, and GNSS for providing precise absolute positioning. New vehicle connections are created, which include, for example, connections by cellular (LTE and 5G), Wireless Local Area Network (WLAN) or DSRC. These and other connections create a need for new and additional antennas. As the number of antennas on a vehicle increases, the size and the quantity of the structures required for housing the antennas increases, which may interfere with the design and styling of the vehicle. Because of this, car engineers and designers are looking for suitable areas on the vehicle to place antennas that do not interfere with vehicle design and structure. Integration of antennas within vehicle glass offers improved aesthetics, simplified antenna packaging, reduced weight, decreased or eliminated chances for vandalism and damage caused by water leakage, and the reduced need for drilling metal holes or apertures into the body of the vehicle.

With 2G, 3G, and 4G LTE technologies, an additional spectrum was introduced beyond previously used 800 MHz, 900 MHz, and 1710-2100 MHz bands. Primarily occupied spectra high frequency bands extended up to 2700 MHz worldwide. In 5G, sub-6 GHz bands have an additional spectrum in 700 MHz bands and 3.4-5.0 GHz bands.

U.S. Pat. No. 10,608,341 B2 illustrates a slot antenna fed by a coplanar waveguide tuned for 4G LTE frequency bands. A set of asymmetric tuning tubs is introduced in the slot for improving the antenna bandwidth. The dimension of the antenna is too big and it's impracticable to be embedded in the glass or on the glass surfaces. U.S. Pat. No. 10,910,692 discloses a coplanar slot antenna fed by a transmission line for transmitting and receiving 4G LTE signals that can be integrated into a laminated windshield with the antenna structure situated between the outer glass ply and the inner glass ply. To laminate the antenna into a windshield, the antenna and transmission line film need to be placed between two layers of PVBs at a designed position which complicates the glass assembly process with more cost to the glass fabrication. In addition, the antenna only covers 4G LTE frequency bands. US Patent Application No. 2022/0416399 discloses a Vivaldi antenna that can be integrated into a windshield in the corners of the window glass behind the black paint band so that the antenna is invisible. Since the Vivaldi antenna has a single beam with maximal gain towards the opening of the antenna slot, the antenna placed on the corners of the windshield would have the antenna radiation beam tilted up or down making it not suitable for receiving mobile communication signals since they are transmitted in the terrestrial angles. U.S. Pat. No. 10,297,897 discloses a slot antenna that can be printed on the surface of back window glass between the defogger line and the bottom edge of the glass. The antenna only covers 4G LTE frequency bands.

Therefore, there is a need for a cellular antenna that can be disposed or attached to the surface of a vehicle glass, but do not protrude from the exterior of the vehicle or into interior the passenger compartment. There is also a need for such an antenna that can be incorporated into existing parts as standard equipment at minimum cost. There is further need for such antenna that does not significantly change the aesthetic or appearance of the vehicle, and which only require minimal modification of existing glass structure and manufacturing process. Finally, there is an additional need for a single antenna having wide band characteristics that can cover the entire 4G LTE and 5G sub-6 GHz frequency bands and the potential for future bands.

### SUMMARY OF THE INVENTION

In some embodiments or aspects, the present disclosure may be characterized by one or more of the following numbered clauses:

Clause 1. An antenna assembly comprising: a dielectric substrate; a plurality of conductive sheets disposed on a side of the dielectric substrate; a plurality of notch radiators defined between at least two of the plurality of conductive sheets; and a transmission line electrically connected to at least one of the conductive sheets.

Clause 2. The antenna assembly of clause 1, wherein the plurality of conductive sheets each comprise a curved edge, and wherein the plurality of notch radiators are defined between adjacent curved edges.

Clause 3. The antenna assembly of clause 2, wherein a first pair of adjacent curved edges define a first feed opening therebetween, wherein a second pair of adjacent curved edges define a second feed opening therebetween, and wherein the first feed opening is parallel to the second feed opening.

Clause 4. The antenna assembly of clause 3, wherein the first feed opening and the second feed opening define an antenna feed point proximate to a midpoint between the first feed opening and the second feed opening, and wherein the transmission line is electrically connected to the first feed opening and the second feed opening at the antenna feed point.

Clause 5. The antenna assembly of any of clauses 1-4, wherein the plurality of notch radiators are configured to be excited at odd modes.

Clause 6. The antenna assembly of any of clauses 1-5, wherein the plurality of notch radiators are configured to create a plurality of electrical fields, and wherein adjacent electrical fields of the plurality of electrical fields are out of phase.

Clause 7. The antenna assembly of any of clauses 1-6, wherein the plurality of notch radiators are configured to generate a plurality of main beams, each extending in a different direction.

Clause 8. The antenna assembly of clause 7, wherein the plurality of main beams are configured to extend in a direction of a mouth defined by each of the plurality of notch radiators.

Clause 9. The antenna assembly of any of clauses 4-8, wherein the transmission line comprises a T-shaped microstrip line comprising a first branch, a second branch, and a third branch, wherein the second branch extends across the first feed opening, and the third branch extends across the second feed opening, and wherein the first branch is connected to the second branch and the third branch proximate a midpoint of the transmission line.

Clause 10. The antenna assembly of any of clauses 4-9, wherein the plurality of conductive sheets comprises a first conductive sheet, a second conductive sheet, and a third conductive sheet, wherein the first conductive sheet comprises a first curved edge, wherein the second conductive sheet comprises a second curved edge and a third curved edge, wherein the third conductive sheet comprises a fourth curved edge, wherein the first feed opening is defined between the first curved edge and the second curved edge, and wherein the second feed opening is defined between the third curved edge and the fourth curved edge.

Clause 11. The antenna assembly of clause 10, wherein the plurality of notch radiators comprise: a first notch radiator defined between the first curved edge and the second curved edge on a first side of the conductive sheet; a second notch radiator defined between the first curved edge and the second curved edge on a second side of the first conductive sheet; a third notch radiator defined between the second curved edge and the third curved edge on a first side of the third conductive sheet; and a fourth notch radiator defined between the second curved edge and the third curved edge on a second side of the third conductive sheet.

Clause 12. The antenna assembly of clause 10 or 11 further comprising a feed line extending from the first feed opening to the second feed opening, and wherein the transmission line further comprises a coaxial cable having a center conductor connected proximate to a midpoint of the feed line.

Clause 13. The antenna assembly of clause 12, wherein a first end of the feed line is connected to the first conductive sheet and extends across the first feed opening, wherein a second end of the feed line is connected to the third conductive sheet and extends across the second feed opening, and wherein the coaxial cable comprises a shield connected to the second conducive sheet proximate to the antenna feed point.

Clause 14. The antenna assembly of any of clauses 4-13, wherein the plurality of conductive sheets comprises a first conductive sheet and a second conductive sheet, wherein the first conductive sheet comprises a first curved edge, wherein the second conductive sheet comprises a second curved edge and a third curved edge, wherein the first curved edge and the second curved edge define the first feed opening, wherein the third curved edge defines the second feed opening and an impedance matching opening, wherein the plurality of notch radiators comprise: a first notch radiator defined between the first curved edge and the second curved edge on a first side of the first conductive sheet; a second notch radiator defined between the first curved edge and the second curved edge on a second side of the first conductive sheet; and a third notch radiator defined between the second curved edge and the third curved edge.

Clause 15. The antenna assembly of clause 14, wherein an angle between a center line of the first notch radiator and a center line of the second notch radiator is tunable, and wherein an angle between the center line of the second notch radiator and a center line of the third notch radiator is tunable.

Clause 16. An antenna window assembly comprising: an outer transparent ply comprising a first surface and a second surface opposite the first surface; an inner transparent ply comprising a third surface and a fourth surface opposite the third surface; an interlayer disposed between the second surface and the third surface; a plurality of conductive sheets arranged on the fourth surface; a plurality of notch radiators defined between at least two of the plurality of conductive sheets; and a transmission line electrically connected to the plurality of notch radiators by way of at least one of the conductive sheets.

Clause 17. The antenna window assembly of clause 16, wherein the plurality of conductive sheets comprise a first conductive sheet and a second conductive sheet, and wherein the plurality of notch radiators are defined on opposing sides of the second conductive sheet.

Clause 18. The antenna window assembly of clause 17, wherein at least one notch radiator of the plurality of notch radiators is defined between opposing sides of the second conductive sheet.

Clause 19. The antenna window assembly of clause 17 or 18, wherein the plurality of conductive sheets further comprise a third conductive sheet, and wherein a first portion of the plurality of notch radiators are defined between the first conductive sheet and the second conductive sheet, and a second portion of the plurality of notch radiators are defined between the second conductive sheet and the third conductive sheet.

Clause 20. The antenna window assembly of any of clauses 16-19, wherein the plurality of conductive sheets define a plurality of edges, wherein a first pair of the plurality of edges defines a first feed opening therebetween, wherein a second pair of the plurality of edges defines a second feed opening, and wherein the transmission line is electrically connected to the first feed opening and second feed opening at a point between the first feed opening and the second feed opening.

### BRIEF DESCRIPTION OF THE DRAWING(S)

FIG. 1 is a top view of a vehicle having an antenna according to one embodiment or aspect of the present disclosure.

FIG. 2 is a first partial cross-sectional view of the vehicle of FIG. 1 along line 2-2;

FIG. 3 is a second partial cross-sectional view of the vehicle of FIG. 1 along line 2-2;

FIG. 4 is a top view of a notch antenna according to one embodiment or aspect of the present disclosure;

FIG. 5 is a top view of an antenna feed structure and microchip line according to one embodiment or aspect of the present disclosure;

FIG. 6 is a first exemplary top view of an antenna feed structure having four notch radiators according to one embodiment or aspect of the present disclosure;

FIG. 7 is a second exemplary top view of an antenna feed structure having four notch radiators according to one embodiment or aspect of the present disclosure;

FIG. 8 is an exemplary top view of an antenna structure having three notch radiators according to one embodiment or aspect of the present disclosure; and

FIG. 9 is an exemplary graph illustrating the measured frequency response of an antenna.

### DESCRIPTION OF THE INVENTION

For purposes of the description hereinafter, the terms “upper”, “up”, “lower”, “down”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

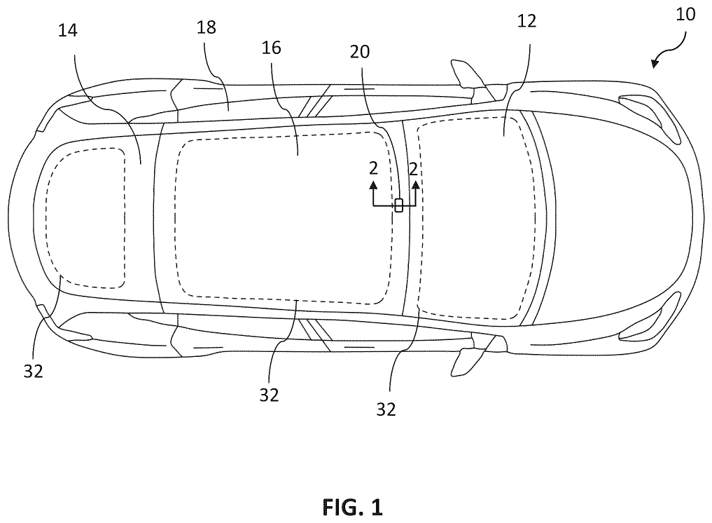

The present disclosure relates to antennas 20 used in glass, such as glass used in motor vehicles 10, an example of which is shown in FIG. 1. The antennas 20 are used to resonate at different bands to pick up and receive signals that can be used for GNSS (Global Navigation Satellite System), Wi-Fi, V2V/V2X, LTE/5G and other applications. While some or all of these signals and applications may be used in connection with a motor vehicle 10, the antennas 20 disclosed are not intended to be limited to use in motor vehicles 10 like the one shown. One will appreciate that the antennas 20 can be used with glass in other applications. For example, the antennas can be used with other vehicles or modes of transportation, such as trucks, busses, boats and airplanes. In other examples, the antennas 20 can be used in non-vehicular glass applications, such as on building windows or within smart glass or privacy glass used inside of buildings.

With reference to FIG. 1, a motor vehicle 10 (hereinafter the “vehicle”) having an antenna 20 according to one non-limiting aspect or embodiment of the present disclosure is shown. The vehicle 10 includes a windshield 12, back window 14, roof window 16, and passenger windows 18. The windshield 12, back window 14, roof window 16, and passenger windows 18 are typically made of glass. The windshield 12, back window 14, and roof window 16 include respective concealment bands 32 extending about a perimeter thereof. The concealment bads 32 conceal different elements of the antenna 20 and other electronic devices located around the edges of the respective windows 12, 14, 16. Generally, the concealment bands 32 may be applied by screen printing an opaque ink onto the glazing of the glass and firing the perimeter of the glass. The windshield 12, back window 14, and roof window 16 are held within a body of the vehicle 10. The antenna 20 may be arranged in or around any one of the windows 12, 14 16. However, as shown, the antenna 20 is formed in and around the roof window 16. Preferably, the antenna 20 may be arranged within an area around the concealment band 32 to minimize the visibility thereof. The area where the antenna 20 is located is known as the silhouette of the concealment band 32.

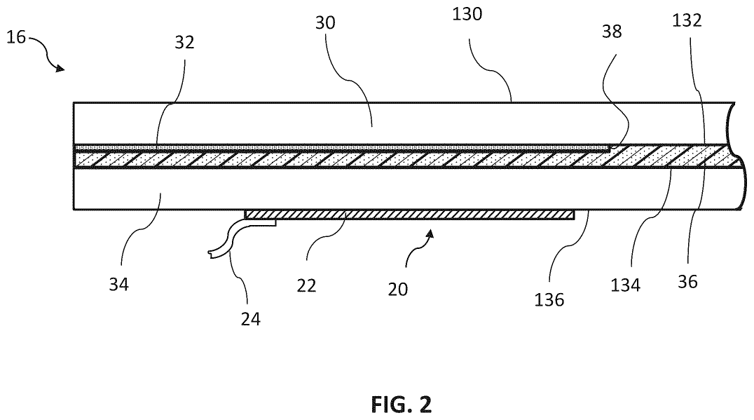

With reference to FIG. 2, a partial cross-sectional view of antenna 20 in roof 16 is shown. The roof window 16 is a laminated glazing and may be referred to as such throughout this disclosure. The glazing 16 includes an inner transparent ply 34 and an outer transparent ply 30. the transparent plies 34, 36 may be made of glass. The inner ply 34 and outer ply 30 are bonded together by an interlayer 36. The interlayer 36 may be made of a polyvinyl butyral (PVB) or similar material such as polyethylene terephthalate (PET). The outer ply 30 has an outer surface 130 that defines the outside or outwardly facing surface of roof window 16. The outer surface 130 may be conventionally referred to as a first surface. The outer ply 30 also defines an inner surface 132 that is oppositely disposed on the outer ply 30 from the outer surface 130. The inner surface 132 may be conventionally referred to as a second surface. The inner ply 34 has an outer surface 134 that faces away from the vehicle passenger compartment and faces internally in glazing 16 so that it is opposite inner surface 132 of outer transparent ply 30. The outer surface 134 may be conventionally referred to as a third surface. Inner transparent ply 34 also defines an inner surface 136 that defines the inside or inwardly facing surface of the glazing 16 such that it faces internally to the passenger compartment of the vehicle. Interlayer 36 is located between surfaces 132 and 134. The inner surface 136 may be conventionally referred to as a fourth surface.

As shown in FIGS. 1 and 2, the glazing 16 may include concealment band 32 such as a paint band that is applied to outer ply 30 by screen printing opaque ink around the perimeter of the inner surface 132 of the outer ply 30 and then firing the perimeter of the outer ply 30. Concealment band 32 has a closed inner edge 38 that defines the boundary of the daylight opening (DLO) of glazing 16. The concealment band 32 is sufficiently wide to cover the antenna elements of the glazing 16 as well as other equipment that may be arranged near the outer perimeter of glazing 16 as hereinafter shown and described.

One or more conductive layers 22 are disposed or formed on outer surface 136 of the inner ply 34. The interlayer 36, inner ply 34 and outer ply 30 act as a dielectric substrate for the conductive layers 22. A transmission line 24 is connected to the conductive layers 22. Antenna 20 is arranged on and may include conductive layers 22. Antenna 20 may also be printed directly on outer surface 136 and conductive layers 22 may be omitted.

The conductive layer 22 may be implemented in many ways that are given by way of example here. However, one will appreciate that other implementations not described may be used. The conductive layers 22 may be a conductive paint, a metallic film deposited by sputtering or vapor deposition, or a silver past screen meshed to a nonconductive panel. Furthermore, the conductive layers 22 may be formed on the surfaces of a single layer nonconductive pane such as a tempered glass window, or the surfaces of any one of the multilayer glass or plastic layers of a laminated transparency or bonded on the surfaces of a non-conductive body panel, such as fiberglass, interior or exterior panel.

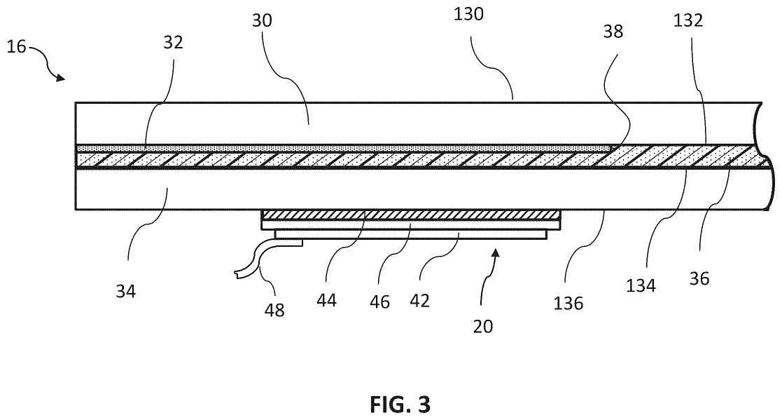

With reference to FIG. 3 a partial cross-sectional view of a second embodiment of antenna 20 on roof glazing 16 is shown. Roof glazing 16 includes an inner transparent ply 34, an outer transparent ply 30 and a PVB interlayer 36 therebetween. One or more conductive layers 42 are arranged on outer surface 136 of inner ply 34. The conductive layers 42 are arranged or formed on a thin, flexible film substrate 46, such as polyester (PET), Kapton, mylar, or any other flexible dielectric substrate. Conductive layers 42 and film substrate 46 are secured to inner surface 136 of inner ply 34 by an adhesive layer 44. The adhesive layer 44 can be any suitable adhesive or transfer tape that effectively allows the substrate 46 to be secured to the inner ply 34. A transmission line 48 is shown connected to the conductive layer 42. Antenna 20 is arranged on and may include conductive layer 42. As with FIG. 2, antenna 20 may be printed directly on outer surface 136 and conductive layer 42, film substrate 46, and adhesive layer 44 may be omitted.

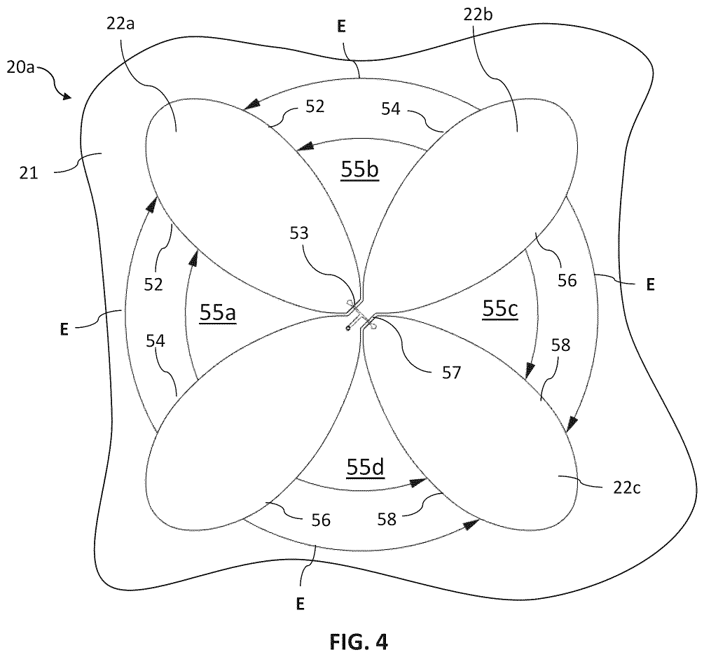

With reference to FIG. 4, a first example of antenna 20a is shown. Antenna 20a includes a dielectric substrate 21, which may be the outer ply 30, interlayer 36, and/or inner ply 34, and a plurality of conductive sheets or layers 22 disposed on one surface of the substrate 21, which define a plurality of notch radiators 55. As stated above, antenna 20a may be printed on the outer surface 136 of the inner transparent ply 34 and conductive layers 22, 42 and associated layers may be omitted. In this instance, the outer ply 30, the PVB interlayer 36 and the inner ply 34 act as the substrate 21. As shown, a first conductive sheet 22a, second conductive sheet 22b, and third conductive sheet 22c are arranged on the substrate 21. As shown, the conductive sheets 22a, 22b, 22c take the general shape of oval bulges and are arranged generally symmetrically across the substrate 21. The second conductive sheet 22b extends diagonally from a bottom left corner to a top right corner. The first conductive sheet 22a and third conductive sheet 22c extend from proximate a center of the second conductive sheet 22b, with the first conductive sheet 22a extending to a top left corner, and the third conductive sheet 22c extending to a bottom right corner.

The first and second conductive sheets 22a, 22b, have adjacent facing edges 52, 54 that extend across the surface of substrate 21 and are spaced apart relative to one another. As shown, the adjacent facing edges 52, 54 are curved, such that the first and second conductive sheets 22a, 22b approach one another to form a first feed slot opening 53 proximate to a center of the antenna 20a and conductive sheets 22a, 22b, 22c and define a first feed point therebetween. The first and second conductive sheets 22a, 22b form a first flared notch radiator 55a and a second flared notch radiator 55b between the adjacent facing edges 52, 54. The first notch radiator 55a extends from the first end of the first feed slot opening 53 to a first side of substrate 21. The first notch radiator 55a generally increases in surface area from the first end of the first feed slot opening 53 in the direction the first side of substrate 21. The second notch radiator 55b is similarly arranged and extends from the second end of the first slot feed opening 53 to a second side of substrate 21. The second notch radiator 55b generally increases in surface area from the second end of the first feed slot opening 53 in the direction of the second side of substrate 21.

The second and third conductive sheets 22b, 22c have adjacent facing edges 56 and 58 that extend across the surface of substrate 21 and are spaced apart relative to one another. As shown, the adjacent facing edges 56, 58 are curved, such that the second and third conductive sheets 22b, 22c approach one another to form a second feed slot opening 57, proximate to a center of the antenna 20a and conductive sheets 22a, 22b, 22c, and define a second feed point therebetween. The second and third conductive sheets 22b, 22c form a third flared notch radiator 55c and a fourth flared notch radiator 55d between the adjacent facing edges 56, 58. The third notch radiator 55c extends from the first end of the second feed slot opening 57 to a third side of substrate 21. The third notch radiator 55c generally increases in surface area from the first end of the second feed slot opening 57 in the direction of the third side of substrate 21. The fourth notch 55d is similarly arranged and extends from the second end of the second feed slot opening 57 to a fourth side of substrate 21. The fourth notch radiator 55d generally increases in surface area from the second end of the second feed slot opening 57 in the direction of the fourth side of substrate 21.

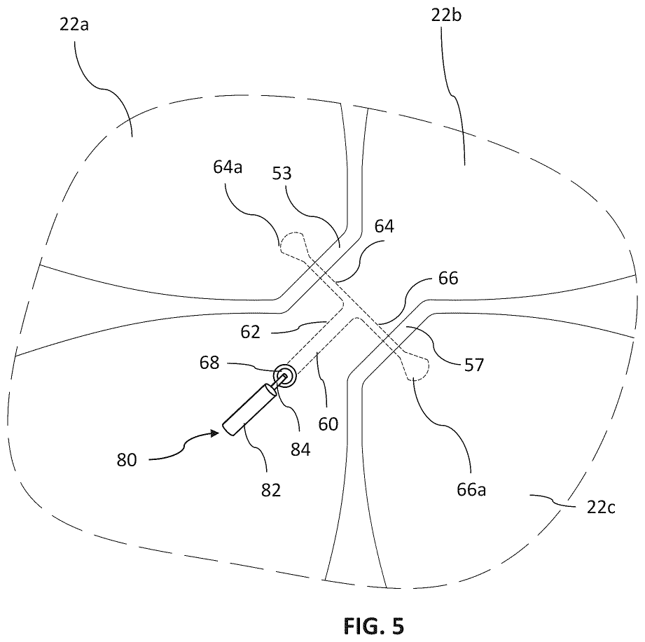

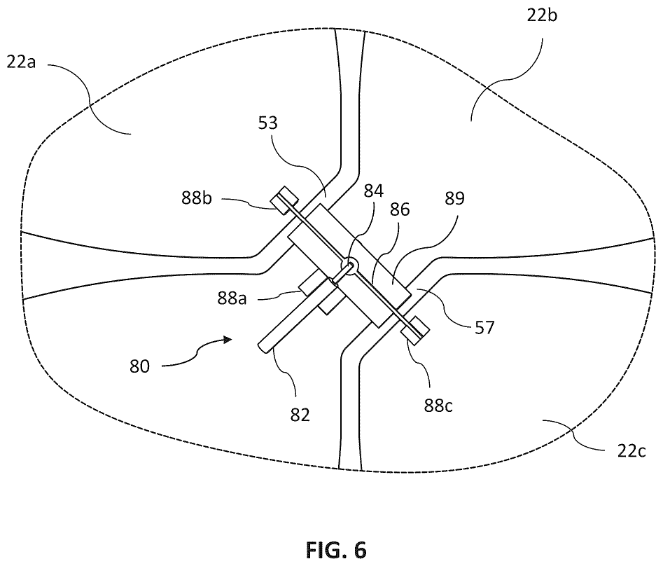

The first feed slot opening 53 and the second feed slot opening 57 are arranged in close proximity and in parallel to each other. An antenna feed line extends across the first feed slot opening 53 and the second slot feed slot opening 57 at a 90 degree angle to feed all four notch radiators 55a, 55b, 55c, 55d in-phase to excite odd modes of the antenna 20a. Examples of antenna feed line are shown and discussed in connection with FIGS. 5 and 6 below. The electrical fields that are created by and/or within adjacent notch radiators 55a, 55b, 55c, 55d are out of phase as illustrated in FIG. 4 by field lines designated by the letter E. In the example shown in FIG. 4, the electrical field of the first notch radiator 55a is out of phase with the electrical fields of the second and fourth notch radiators 55b, 55d, and the electrical field of the second notch radiator 55b is out of phase with the electrical fields of the first and third notch radiators 55a, 55c. Antennas that use four notch radiators have four signal beams directing towards different sides of the substrate 21 that provides better signal coverage than a notch antenna with a single beam. In the example shown in FIG. 4, each notch radiator 55a, 55b, 55c, 55d generates a main beam that is directed to the four sides of the substrate 21, which is in the direction of the mouth of each flared notch opening defined by the notch radiators 55a, 55b, 55c, 55d. In the example shown in FIG. 4, the main beams of each notch radiator 55a, 55b, 55c, 55d extend in the left, up, right, and down directions towards the sides of the substrate 21. This antenna 20 may be configured to transmit and receive 5 G sub-6 GHz and 4G LTE cellular signals.

With reference to FIG. 5, a first feeding structure 60, also known as an antenna feed line, for the antennas 20 is shown. The antennas 20 may be fed by a T-shaped microstrip line 60 that is formed on the bottom side of the substrate 21, opposite the side on which the conductive sheets 22a, 22b, 22c are arranged. The T-shaped microstrip line 60 has a first branch 62, second branch 64, and third branch 66. The second branch 64 and third branch 66 are equal in length and extend in opposing directions from an end of the first branch 62. The first and second notch radiators 55a, 55b are excited capacitively by electromagnetic coupling between the second branch 64 and the first feeding slot opening 53. Third and fourth notch radiators 55c, 55d are excited capacitively by electromagnetic coupling between the third branch 66 and the second feeding slot opening 57. The characteristic impedance and the width of each branch 62, 64, 66 of the microstrip line 60 affect electromagnetic coupling to the first feeding slot opening 53 and the second feeding slot opening 57. For example, for maximum coupling, the second and third branches 64, 66 are oriented with respect to the first feeding slot opening 53 and the second feeding slot opening 57 such that the longitudinal dimension of the branches 64, 66 define right angles with their respective first feeding slot opening 53 and second feeding slot opening 57. After crossing the first feeding slot opening 53 and the second feeding slot opening 57, respectively, second and third branches 64, 66 terminate with an open circuit quarter-wavelength radial stud 64a, 66a intended for wideband antenna matching, respectively. The end of the first branch 62 that is opposite the second and third branches 64, 66 is connected to the center conductor 84 of a coaxial cable 80 through a via 68. The shield 82 of the coaxial cable 80 is connected to the second conductive sheet 22b at a point near the via 68.

With reference to FIG. 6, a second feeding structure for antennas 20 is shown. The antennas 20 may be fed directly through the first feed slot opening 53 and the second feed slot opening 57 by a coaxial cable 80 that has a center conductor 84 and an outer shield 82. The center conductor 84 is connected to the middle of a feed line 86 that extends between and connects the first feed slot opening 53 and the second feed slot opening 57. The middle feed line 86 is connected to the first feed slot opening 53 and second feed slot openings 57 at their respective ends facing the second conductive sheet 22b. A first end of the middle feed line 86 is galvanically connected to the side of the first feed slot opening 53 that faces the first conductive sheet 22a by a solder pad 88b arranged on the conductive sheet 22a. A second end of the middle feed line 86 is galvanically connected to the side of the second feed slot opening 57 that faces the third conductive sheet 22c by a solder pad 88c arranged on the conductive sheet 22c. Outer shield 82 may be galvanically connected to the second conductive sheet 22b by a solder pad 88a near the antenna feeding point. The center conductor 84 and the middle feed line 86 are isolated from the second conductive sheet 22b by an insulation layer 89 secured to the surface of the second conductive sheet 22b by an adhesive layer. An antenna 20 directly fed by a coaxial cable may be preferable because the entire antenna can be part of the glass without an additional antenna feed substrate 21.

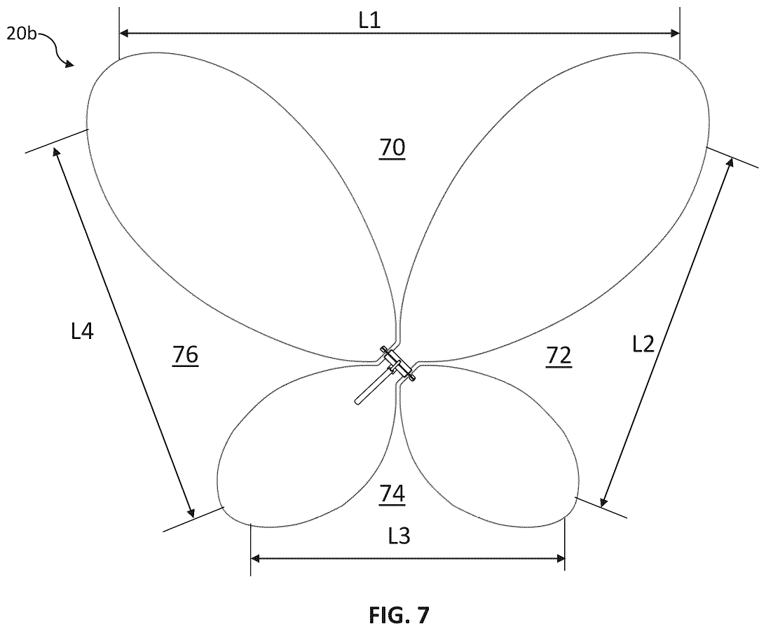

With reference to FIG. 7, is a second example of an antenna 20b is shown. For a flared notch antenna, it is generally required that the length of the opening end should be greater or equal to a half wavelength at minimum operating frequency. The antenna 20b may have four notch radiators 70, 72, 74 and 76 where first notch radiator 70 has a first mouth opening width of L1, second notch radiator 72 has a second mouth opening width of L2, third notch radiator 74 has a third mouth opening width of L3, and fourth notch radiator 76 has a fourth mouth opening width of L4. The first mouth opening width L1 is greater than the fourth mouth opening width L4. The fourth mouth opening width L4 is greater than the second mouth opening width L2. The second mouth opening width L2 is greater than the third mouth opening width L3. Each notch radiator 70, 72, 74, 76 can be tuned for a frequency band of different applications, for example, The first notch radiator 70 may be tuned for mobile LTE antenna with lower frequency tuned to 700 MHz and notch radiators 76, 72, and 74 may be tuned to GNSS 1.2/1.6 GHz, Wi-Fi 2.4/5 GHz, or V2V 5.8 GHz frequency bands, respectively.

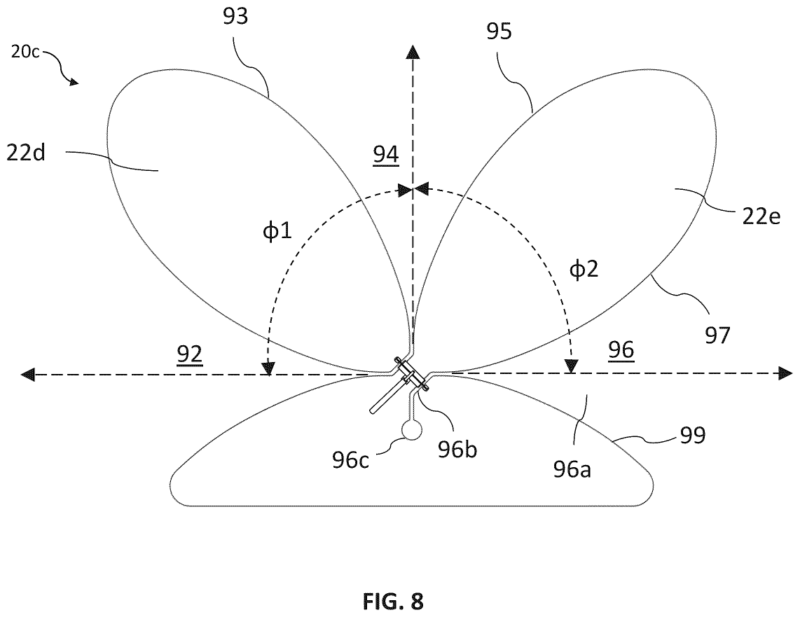

With reference to FIG. 8, a third example of an antenna 20c is shown. The antenna 20c includes a first conductive sheet 22d and a second conductive sheet 22e, having respective adjacent facing edges 93, 95 that extend across the surface of a substrate (not shown). The adjacent facing edges 93, 95 are curved, such that they are spaced apart from each other to form first and second flared notch radiators 92, 94 therebetween. The second conductive sheet 223 is shaped, such that a third notch radiator 96 is formed between its own adjacent facing edges 97, 99, which are arranged on the substrate generally opposite from the first conductive sheet 22d. The adjacent facing edges 97, 99 have curved portions extending outward from proximate a center of antenna 20c and conductive sheets 22d, 22e and are arranged to define feed opening 96b, a tapered opening 96a, and an impedance matching opening 96c on the second conductive sheet 22e. As shown, the impedance matching opening 96c is formed in an oval shape adjacent to an end of the slot opening 96b. The impedance matching opening 96c is arranged to act as an open circuit to the third notch radiator 96. Each notch radiator 92, 94, 96 has a main radiation beam that is directed towards a center of their respective mouth openings. In other words, the main radiation beams of each notch radiator 92, 94, 96 are directed towards respective ends of the substrate. The angle φ1 between the center line of first notch radiator 92 and second notch radiator 94 and the angle φ2 between the center line of second notch radiator 94 and third notch radiator 96 are adjustable depending on the signal coverage requirement for the antenna and the physical location of the antenna. The angles φ may be tunable between 30 degrees and 180 degrees.

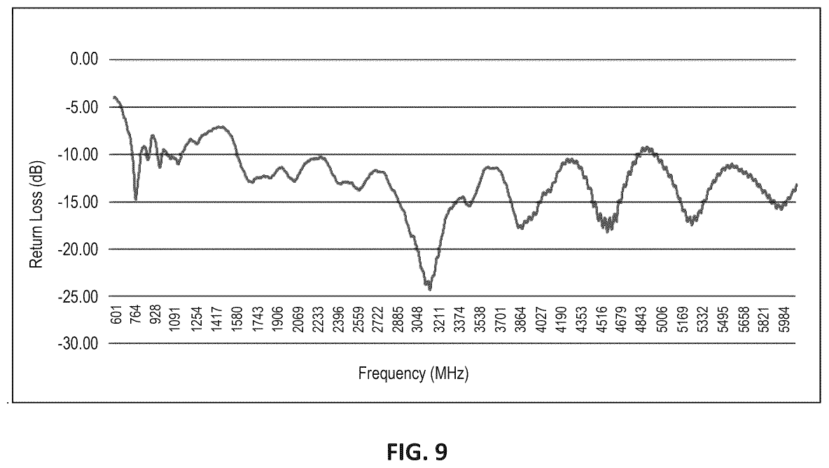

An embodiment of the antenna 20c shown in FIG. 8 with a coaxial cable feed as shown on FIG. 6 was fabricated on a roof window 16 and measured on an electric vehicle. The wideband antenna has a total length of 125 mm and width of 100 mm designed for operating at a minimum frequency of 617 MHz. The antenna 20c was printed on inner surface 136 of inner ply 34. The thickness of the inner and outer plies were 2.1 mm with a relative dielectric constant of 7.5 and a loss tangent (tan δ) of 0.02. The thickness of interlayer 36 was 0.8 mm with a relative dielectric constant of 3.3 and a loss tangent (tan δ) of 0.05. The antenna 20c was positioned on the front center of the roof window 16 and behind the black paint band with three notch radiators facing towards the rear and sides of the vehicle. FIG. 9 illustrates a measured return loss (S11) performance of the antenna. Of the power delivered to the antenna, return loss S11 is a measure of how much power is reflected from the antenna 20c and how much is “accepted” by the antenna and radiated. As shown in FIG. 9 the frequency response of the antenna is well matched from 617 MHz to 6.0 GHz. The antenna shows the wideband nature that covers the entire 4G LTE bands and 5G sub-6 bands. The antenna may be printed on windshield, back window, and side windows for better coverage to form an antenna diversity system with a nearly omnidirectional far field radiation pattern in the terrestrial direction.

While the invention has been described and illustrated by reference to certain preferred embodiments and implementations, it should be understood that various modifications may be adopted without departing from the spirit of the invention or the scope of the following claims.

1. An antenna assembly comprising:
a dielectric substrate;
a plurality of conductive sheets disposed on a side of the dielectric substrate;
a plurality of notch radiators defined between at least two of the plurality of conductive sheets; and
a transmission line electrically connected to at least one of the conductive sheets.

2. The antenna of claim 1, wherein the plurality of conductive sheets each comprise a curved edge, and
wherein the plurality of notch radiators are defined between adjacent curved edges.

3. The antenna of claim 2, wherein a first pair of adjacent curved edges define a first feed opening therebetween,
wherein a second pair of adjacent curved edges define a second feed opening therebetween, and
wherein the first feed opening is parallel to the second feed opening.

4. The antenna of claim 3, wherein the first feed opening and the second feed opening define an antenna feed point proximate to a midpoint between the first feed opening and the second feed opening, and
wherein the transmission line is electrically connected to the first feed opening and the second feed opening at the antenna feed point.

5. The antenna of claim 1, wherein the plurality of notch radiators are configured to be excited at odd modes.

6. The antenna of claim 1, wherein the plurality of notch radiators are configured to create a plurality of electrical fields, and
wherein adjacent electrical fields of the plurality of electrical fields are out of phase.

7. The antenna of claim 1, wherein the plurality of notch radiators are configured to generate a plurality of main beams, each extending in a different direction.

8. The antenna of claim 7, wherein the plurality of main beams are configured to extend in a direction of a mouth defined by each of the plurality of notch radiators.

9. The antenna of claim 4, wherein the transmission line comprises a T-shaped microstrip line comprising a first branch, a second branch, and a third branch,
wherein the second branch extends across the first feed opening, and the third branch extends across the second feed opening, and
wherein the first branch is connected to the second branch and the third branch proximate a midpoint of the transmission line.

10. The antenna of claim 4, wherein the plurality of conductive sheets comprises a first conductive sheet, a second conductive sheet, and a third conductive sheet,
wherein the first conductive sheet comprises a first curved edge,
wherein the second conductive sheet comprises a second curved edge and a third curved edge,
wherein the third conductive sheet comprises a fourth curved edge,
wherein the first feed opening is defined between the first curved edge and the second curved edge, and
wherein the second feed opening is defined between the third curved edge and the fourth curved edge.

11. The antenna of claim 10, wherein the plurality of notch radiators comprise:
a first notch radiator defined between the first curved edge and the second curved edge on a first side of the first conductive sheet;
a second notch radiator defined between the first curved edge and the second curved edge on a second side of the first conductive sheet;
a third notch radiator defined between the second curved edge and the third curved edge on a first side of the third conductive sheet; and
a fourth notch radiator defined between the second curved edge and the third curved edge on a second side of the third conductive sheet.

12. The antenna of claim 10 further comprising a feed line extending from the first feed opening to the second feed opening, and
wherein the transmission line further comprises a coaxial cable having a center conductor connected proximate to a midpoint of the feed line.

13. The antenna of claim 12, wherein a first end of the feed line is connected to the first conductive sheet and extends across the first feed opening,
wherein a second end of the feed line is connected to the third conductive sheet and extends across the second feed opening, and
wherein the coaxial cable comprises a shield connected to the second conducive sheet proximate to the antenna feed point.

14. The antenna of claim 4, wherein the plurality of conductive sheets comprises a first conductive sheet and a second conductive sheet,
wherein the first conductive sheet comprises a first curved edge,
wherein the second conductive sheet comprises a second curved edge and a third curved edge,
wherein the first curved edge and the second curved edge define the first feed opening,
wherein the third curved edge defines the second feed opening and an impedance matching opening,
wherein the plurality of notch radiators comprise:
a first notch radiator defined between the first curved edge and the second curved edge on a first side of the first conductive sheet;
a second notch radiator defined between the first curved edge and the second curved edge on a second side of the first conductive sheet; and
a third notch radiator defined between the second curved edge and the third curved edge.

15. The antenna of claim 14, wherein an angle between a center line of the first notch radiator and a center line of the second notch radiator is tunable, and
wherein an angle between the center line of the second notch radiator and a center line of the third notch radiator is tunable.

16. An antenna window assembly comprising:
an outer transparent ply comprising a first surface and a second surface opposite the first surface;
an inner transparent ply comprising a third surface and a fourth surface opposite the third surface:
an interlayer disposed between the second surface and the third surface;
a plurality of conductive sheets arranged on the fourth surface;
a plurality of notch radiators defined between at least two of the plurality of conductive sheets; and
a transmission line electrically connected to the plurality of notch radiators by way of at least one of the conductive sheets.

17. The antenna window assembly of claim 16, wherein the plurality of conductive sheets comprise a first conductive sheet and a second conductive sheet, and
wherein the plurality of notch radiators are defined on opposing sides of the second conductive sheet.

18. The antenna window assembly of claim 17, wherein at least one notch radiator of the plurality of notch radiators is defined between opposing sides of the second conductive sheet.

19. The antenna window assembly of claim 17, wherein the plurality of conductive sheets further comprise a third conductive sheet, and
wherein a first portion of the plurality of notch radiators are defined between the first conductive sheet and the second conductive sheet, and a second portion of the plurality of notch radiators are defined between the second conductive sheet and the third conductive sheet.

20. The antenna window assembly of claim 16, wherein the plurality of conductive sheets define a plurality of edges,
wherein a first pair of the plurality of edges defines a first feed opening therebetween,
wherein a second pair of the plurality of edges defines a second feed opening, and
wherein the transmission line is electrically connected to the first feed opening and second feed opening at a point between the first feed opening and the second feed opening.
